(19) United States
(12) Patent Application Publication
(10) Pub. No.: US 2007/0274021 A1
(43) Pub. Date: Nov. 29, 2007

(54) Electrostatic chuck apparatus

(75) Inventors: Shoji Kano, Annaka-shi (JP); Waichi Yamamura, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/797,726

(22) Filed: May 7, 2007

(30) Foreign Application Priority Data
May 25, 2006 (JP) 2006-144877

(51) Int. Cl. H01T 23/00

(52) U.S. Cl. 361/234

(57) ABSTRACT

An electrostatic chuck apparatus for holding a workpiece such as a semiconductor wafer or glass substrate comprises a support substrate, an electrode formed on one surface of the support substrate, and an insulating layer covering the electrode and having a bearing surface for the workpiece. The insulating layer comprises pyrolytic boron nitride containing carbon and at least one element selected from silicon, aluminum, yttrium, and titanium, and has a Vickers hardness Hv of 50 to 1000.

### CROSS-REFERENCE TO RELATED APPLICATION

This non-provisional application claims priority under 35 U.S.C. §119(a) on Patent Application No. 2006-144877 filed in Japan on May 25, 2006, the entire contents of which are hereby incorporated by reference.

### TECHNICAL FIELD

This invention relates to an apparatus having an electrostatic attraction function, commonly referred to as electrostatic chuck (ESC), used in processing and inspection steps during the manufacture of semiconductor devices, liquid crystal panels and the like.

### BACKGROUND ART

In the process of manufacturing semiconductor devices, metal wire wound heaters are traditionally used to heat semiconductor wafers. The heaters of this type, however, give rise to a problem of metal contamination to semiconductor wafers. It was recently proposed to use ceramic monolithic wafer heaters having a ceramic thin film as a heating element as disclosed in JP-A 4-124076.

For heating wafers during molecular beam epitaxy, CVD, sputtering and similar processes, it is regarded effective to use a composite ceramic heater of pyrolytic boron nitride (PBN) and pyrolytic graphite (PG) which produces no outgassing from within the support substrate and has high purity and thermal shock resistance as disclosed in JP-A 63-241921. As compared with prior art tantalum wire heaters, the composite ceramic heater has many advantages including easy mounting and easy use because troubles like thermal deformation, breaks and short-circuits are avoidable. In addition, it is a film heater so that a relatively uniform heat distribution is achievable.

When a semiconductor wafer is to be heated, an electrostatic chuck apparatus is used in a low pressure atmosphere for holding the semiconductor wafer on the heater. As the process temperature elevated, the material of the apparatus changed from resins to ceramics. See JP-A 52-67353 and JP-A 59-124140.

One recent proposal is an electrostatic chuck apparatus having a ceramic monolithic wafer heater combined with an electrostatic chuck. For example, an apparatus using alumina as the insulating layer in the electrostatic chuck is disclosed in New Ceramics, 7, pp. 49-53, 1994. Another exemplary apparatus using aluminum nitride as the insulating layer for improving its resistance to cleaning gas has also been developed.

In these electrostatic chuck apparatus, the electrostatic attraction force becomes stronger as the volume resistivity of the insulating layer becomes lower, as described in New Ceramics, 7, pp. 49-53, 1994. Too low a volume resistivity can cause a device failure due to leakage current. It is then desired that the insulating layer of the electrostatic chuck apparatus have a volume resistivity of 10⁸ to 10¹⁸ Ω-cm, and preferably 10⁹ to 10¹³ Ω-cm.

The electrostatic chucks are classified into three types, depending on the shape of the electrode to which voltage is applied. In chucks of the monopolar type having a single internal electrode, the workpiece should be grounded. By contrast, in chucks of the bipolar type having a pair of internal electrodes and chucks of the comb-shaped electrode type having a pair of comb-shaped electrodes, the workpiece need not be grounded because positive and negative voltages are applied to the paired electrodes. Chucks of the latter type are often used in the semiconductor application.

In the modern molecular beam epitaxy, CVD, and sputtering systems, ceramic electrostatic chuck apparatus are mounted. The semiconductor device manufacturing process often includes steps requiring elevated temperatures beyond 500° C. While the workpiece such as a silicon wafer is held by the electrostatic chuck apparatus, it is heated so that thermal expansion occurs. The thermal expansion gives rise to a phenomenon that noticeable rubs occur between the attracted surface of the workpiece and the attracting or bearing surface of the electrostatic chuck apparatus.

The silicon wafers generally have a Vickers hardness Hv of about 1100. Alumina and aluminum nitride of which the ceramic insulating layer is generally made have a Vickers hardness Hv of 1500 and 1400, respectively. The electrostatic chuck apparatus using alumina and aluminum nitride, which are harder than silicon wafers, in the insulating layer, has the problem that the surface of a silicon wafer can be abraded by the insulating layer in the course of heating and cooling the silicon wafer, generating particles. The attracted surface of the wafer is flawed.

It would be desirable to have an electrostatic chuck apparatus which holds a workpiece by electrostatic attraction force in a high-temperature environment while avoiding flaws on the attracted surface of the workpiece. To solve the outstanding problem, JP-A 2005-072066 proposes a heater/chuck assembly with an electrostatic attraction function, comprising an insulating layer having a surface roughness Ra≦0.05 μm and Rmax≦0.6 μm and a surface Vickers hardness Hv of up to 1000. This insulating layer has poor resistance against oxygen so that it is consumed by oxidation with the remaining oxygen in the semiconductor process chamber. Additionally, when the workpiece is cleaned with a fluorine-based cleaning gas in the process chamber, the insulator can be etched with the cleaning gas. Then, as the number of wafers being processed increases, the insulator undergoes oxidation and etching to a greater extent, allowing for eventual dielectric breakdown.

### DISCLOSURE OF THE INVENTION

An object of the invention is to provide an electrostatic chuck apparatus which holds a workpiece such as a wafer or glass substrate by electrostatic attraction force while avoiding flaws on the attracted surface of the workpiece or the bearing surface of the apparatus, and which has a long lifetime in that it is fully resistant to etching with fluorine-based semiconductor cleaning gas.

According to the invention, there is provided an electrostatic chuck apparatus for holding a workpiece such as a semiconductor wafer or glass substrate, comprising a support substrate, an electrode formed on one surface of the support substrate for producing electrostatic attraction, and an insulating layer covering the electrode and having a bearing surface for the workpiece. The insulating layer comprises pyrolytic boron nitride containing carbon and at least one element selected from silicon, aluminum, yttrium, and titanium, and has a Vickers hardness Hv of 50 to 1000.

The insulating layer is unsusceptible to flaws, has improved oxidation resistance and resistance to etching with fluorine-based cleaning gas, and prevents particle generation and apparatus failure by dielectric breakdown. As a result, the lifetime of the apparatus is prolonged.

### BENEFITS OF THE INVENTION

The electrostatic chuck apparatus of the invention includes an insulating layer covering an electrostatic attraction electrode and having a bearing surface in abutment with a workpiece, wherein the insulating layer has a Vickers hardness Hv of 50 to 1000 at the bearing surface and is made of pyrolytic boron nitride containing carbon and at least one element selected from silicon, aluminum, yttrium, and titanium. Even if a workpiece such as a silicon wafer or glass substrate undergoes thermal cycling while it is held on the bearing surface of the electrostatic chuck apparatus by electrostatic attraction force, neither the attracted surface of the workpiece nor the bearing surface of the apparatus is flawed. The insulating layer has improved resistance to etching with fluorine-based semiconductor cleaning gas. The apparatus thus has a prolonged lifetime.

### BRIEF DESCRIPTION OF THE DRAWING

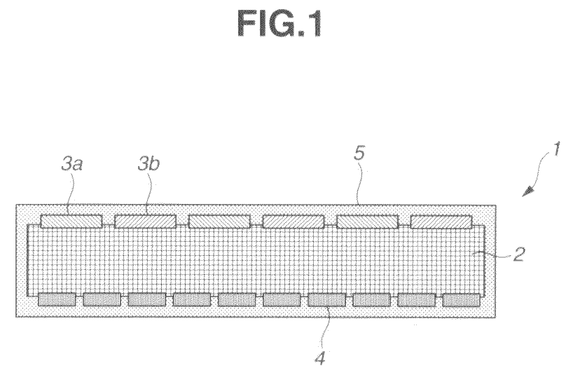

The only figure, FIG. 1 is a cross-sectional view of one exemplary electrostatic chuck apparatus of the invention.

### DESCRIPTION OF THE PREFERRED EMBODIMENTS

The singular forms “a,” “an” and “the” include plural referents unless the context clearly dictates otherwise.

The term “workpiece” refers to a member to be held or clamped in place by the chuck, typically a silicon wafer or glass substrate used in the semiconductor industry.

The electrostatic chuck apparatus of the invention includes a specific insulating layer having a bearing surface on which a workpiece is held by electrostatic attraction force. One embodiment of the electrostatic chuck apparatus is a wafer heating/holding apparatus having heating and electrostatic attraction functions as illustrated in FIG. 1, but the invention is not limited thereto.

The electrostatic chuck apparatus is embodied in FIG. 1 as a heater-bearing assembly 1 having an electrostatic attraction function, which includes a support substrate 2, electrodes 3a, 3b of the bipolar electrostatic attraction type, a heating layer 4, and an insulating layer 5.

Specifically, the electrostatic chuck apparatus includes a support substrate of a sintered composite composed of boron nitride and aluminum nitride, a heating layer of pyrolytic graphite joined to one (back) surface of the substrate, an insulating layer of pyrolytic boron nitride covering the heating layer, electrostatic attraction electrodes of pyrolytic graphite joined to the other (top) surface of the substrate, and an insulating layer covering the electrodes and made of pyrolytic boron nitride containing carbon and at least one element selected from silicon, aluminum, yttrium, and titanium.

The support substrate may be made of any desired material as long as it has heat resistance and insulating properties. For example, a mixture of boron nitride and aluminum nitride is sintered by a known technique. The mixing proportion of boron nitride and aluminum nitride may be in a range from 1:0.05 to 1:1 in weight ratio because a too high proportion of aluminum nitride leads to a higher coefficient of linear expansion and a too low proportion leads to a lower coefficient of linear expansion (see JP-A 8-227933). Also acceptable is a structure in which an insulating layer comprising a material selected from pyrolytic boron nitride, silicon oxide, aluminum nitride, alumina and silicon nitride is joined to carbon, as disclosed in Japanese Patent No. 3,647,064.

The pyrolytic graphite of which the heating layer and the electrodes are made may be produced, for example, by pyrolyzing methane gas at 2200° C. and 5 Torr. The thickness may be in a range of 10 to 300 μm because a too thin layer suffers from poor strength and a too thick layer has a peeling problem.

The invention is characterized by the insulating layer. The electrostatic chuck apparatus for holding a workpiece by electrostatic attraction force comprising an electroconductive heating layer formed on one surface of a support substrate, electroconductive electrodes for electrostatic attraction formed on the other surface of the support substrate, and an insulating layer covering the heating layer and electrodes is characterized in that the insulating layer has a Vickers hardness Hv of 50 to 1000 and comprises pyrolytic boron nitride containing carbon and at least one element selected from silicon, aluminum, yttrium, and titanium. As used herein, the “Vickers hardness” is measured by a hardness tester HV-114, AT-301 by Akashi Mfg. Co., Ltd.

In the event the insulating layer has a Vickers hardness of less than 50, the attracted surface of the workpiece is not flawed, but the bearing surface of the apparatus is frequently flawed and dielectric breakdown occurs in the insulating layer, leading to failure of the apparatus. Also the bearing surface of the apparatus is drastically consumed by rubs, resulting in a shorter lifetime. Rubs also cause particles to generate, frequently rendering the semiconductor device or liquid crystal panel defective.

In the event the insulating layer has a Vickers hardness of more than 1000, the bearing surface of the apparatus is not flawed, but the attracted surface of the workpiece is frequently flawed. This becomes a dust source which frequently causes defectives to the semiconductor device. At the worst, the semiconductor device can be thermally stressed during subsequent heat treatment, so that the wafer breaks away from flaws as the starting point, leading to a loss that the manufacturing line must be interrupted.

The content of carbon in the pyrolytic boron nitride is preferably 0.01 to 10% by weight, more preferably 0.1 to 5% by weight. A carbon content within this range ensures that the insulating layer has a Vickers hardness Hv of 50 to 1000. A carbon content of less than 0.01% by weight may often lead to a Hv of less than 50 whereas a carbon content of more than 10% by weight may often lead to a Hv in excess of 1000.

The content of silicon, aluminum, yttrium and titanium in the pyrolytic boron nitride is preferably 0.01 to 20% by weight. This range ensures that the insulating layer has a Vickers hardness Hv of 50 to 1000. A silicon, aluminum, yttrium and titanium content of less than 0.01% by weight may often lead to a Hv of less than 50 whereas a content of more than 20% by weight may often lead to a Hv in excess of 1000.

The insulating layer should preferably have a surface roughness Ra of less than 1 μm and Rmax of less than 3 μm. A surface roughness beyond the limit leads to a larger surface area of rough portions, with the risk that the layer may be substantially consumed.

The insulating layer may be formed by chemical vapor deposition (CVD). CVD ensures deposition of an insulating layer having a high purity, high density and dimensional precision. That is, the layer has heat resistance, chemical stability, tight adhesion to the underlying, and a minimal chance of dielectric failure or peeling. The CVD layer causes few flaws to the workpiece while the layer itself is unsusceptible to flaws. Thus the apparatus has a long lifetime.

In view of the fact that silicon has a Vickers hardness Hv of 1100, the insulating layer of the invention has a Vickers hardness Hv up to 1000, softer than silicon. The insulating layer is made of pyrolytic boron nitride containing carbon and at least one element selected from silicon, aluminum, yttrium, and titanium. The insulating layer of this composition can be formed on electrodes by CVD, which allows for easy control of the thickness of the insulating layer. Preferably the insulating layer has a thickness of 20 to 300 μm because a too thin layer suffers from poor strength and a too thick layer may reduce the electrostatic attraction force.

An insulating layer of pyrolytic boron nitride containing carbon and silicon may be produced, for example, by placing a substrate in a vacuum chamber, heating at 2000° C., feeding a gas mixture of ammonia, boron trichloride, methane and silicon tetrachloride in a volume ratio of 8:1:1:1, and effecting pyrolysis under 5 Torr. This insulating layer may have a thickness of 50 to 300 μm because a too thin layer is liable to dielectric breakdown and a too thick layer may reduce the electrostatic attraction force.

### EXAMPLE

Examples of the invention are given below by way of illustration and not by way of limitation.

### Example 1 and Comparative Example 1

A carbon disc having a diameter of 200 mm and a thickness of 10 mm was placed in a chamber, where a mixture of ammonia and boron trichloride in a volume ratio of 8:1 was reacted at 2000° C. to deposit pyrolytic boron nitride over the entire surfaces of the disc, producing a disc-shaped support substrate with a coating of 0.5 mm thick.

Then methane gas was pyrolyzed at 2200° C. and 5 Torr, depositing a pyrolytic graphite layer of 100 μm thick on the support substrate. The pyrolytic graphite layer on the top surface was processed into an electrode pattern whereas the pyrolytic graphite layer on the back surface was processed into a heater pattern. In this way, electrostatic attraction electrodes and a heating layer were formed.

On the opposed surfaces, a mixture of ammonia, boron trichloride, methane and silicon tetrachloride in a volume ratio of 8:1:1:1 was reacted under a pressure of 5 Torr and at a temperature of 1600° C., 1700° C., 1800° C., 1900° C. or 2000° C. to deposit an insulating layer of carbon and silicon-containing pyrolytic boron nitride to a thickness of 200 μm, fabricating an electrostatic chuck apparatus. The layer deposited under these conditions contained 5% by weight of carbon and 15% by weight of silicon and had a Vickers hardness Hv of 10 to 1500.

The electrostatic chuck apparatus thus fabricated was heated at 300° C. A wafer was carried over and rested on the apparatus. After 10 seconds, a voltage of ±200 V was applied to the electrodes for holding the wafer in place by electrostatic attraction force and for heating the wafer. Thereafter, CF₄ gas as etchant was fed into the chamber, the voltage was turned off after about 1 minute, and lift pins were raised to release the wafer. The wafer was allowed to stand while continuing the supply of CF₄ gas. The procedure of wafer attraction, release, and standing was repeated 100 cycles. Thereafter, the system was fully cooled down, whereupon the attracted surface of the wafer and the bearing surface of the apparatus were examined for flaws and recesses by etching. When the insulating layer had a Vickers hardness Hv of 50 to 1000, few flaws or recesses were found on the attracted surface of the wafer and the bearing surface of the apparatus, and the insulating layer showed little reduction of thickness.

When the insulating layer had a Vickers hardness Hv of less than 50, flaws and recesses were found on the bearing surface of the apparatus. When the insulating layer had a Vickers hardness Hv of more than 1000, flaws were found on the attracted surface of the wafer.

### Example 2 and Comparative Example 2

Five electrostatic chuck apparatus were fabricated and evaluated by the same procedure as in Example 1 and Comparative Example 1 except that an insulating layer of carbon and silicon-containing pyrolytic boron nitride having a thickness of 200 μm was deposited while varying the amount of methane fed so as to give a mixture of ammonia, boron trichloride, methane and silicon tetrachloride in a volume ratio from 8:1:0.1:1 to 8:1:5:1 and effecting reaction at 1800° C. and 5 Torr. The layers deposited under these conditions had a carbon content of 0.001%, 0.01%, 1%, 10% and 20% by weight and a silicon content of 15% by weight.

The test results demonstrate that when the carbon content is in the range of 0.01 to 10% by weight, no flaws were found on the attracted surface of the wafer and the bearing surface of the apparatus, and the insulating layer showed little reduction of thickness.

When the carbon content is less than 0.01% by weight, flaws and recesses were found on the bearing surface of the apparatus. When the carbon content is more than 10% by weight, flaws were found on the attracted surface of the wafer. A layer with a carbon content of less than 0.01% by weight had a Vickers hardness Hv of less than 50, and a layer with a carbon content of more than 10% by weight had a Vickers hardness Hv in excess of 1000.

### Example 3 and Comparative Example 3

Five electrostatic chuck apparatus were fabricated and evaluated by the same procedure as in Example 1 and Comparative Example 1 except that an insulating layer of carbon and silicon-containing pyrolytic boron nitride having a thickness of 200 μm was deposited while varying the amount of silicon tetrachloride fed so as to give a mixture of ammonia, boron trichloride, methane and silicon tetrachloride in a volume ratio from 8:1:1:0.1 to 8:1:1:10 and effecting reaction at 1800° C. and 5 Torr. The layers deposited under these conditions had a carbon content of 1% by weight and a silicon content of 0.001%, 0.01%, 5%, 20% and 30% by weight.

The test results demonstrate that when the silicon content is in the range of 0.01 to 20% by weight, no flaws or recesses were found on the attracted surface of the wafer and the bearing surface of the apparatus, and the insulating layer showed no reduction of thickness.

When the silicon content is less than 0.01% by weight, flaws and recesses were found on the bearing surface of the apparatus. When the silicon content is more than 20% by weight, flaws were found on the attracted surface of the wafer. A layer with a silicon content of less than 0.01% by weight had a Vickers hardness Hv of less than 50, and a layer with a silicon content of more than 20% by weight had a Vickers hardness Hv in excess of 1000.

While the invention has been described with reference to preferred embodiments, the invention is not limited thereto. The embodiments are merely illustrative of the invention. All embodiments having substantially the same construction as the technical concept of the invention and achieving substantially the same effect fall within the scope of the appended claims.

Japanese Patent Application No. 2006-144877 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An electrostatic chuck apparatus for holding a workpiece, comprising a support substrate, an electrode formed on one surface of the support substrate for producing electrostatic attraction, and an insulating layer covering the electrode and having a bearing surface for the workpiece,
said insulating layer comprising pyrolytic boron nitride containing carbon and at least one element selected from silicon, aluminum, yttrium, and titanium, and having a Vickers hardness Hv of 50 to 1000.

2. The electrostatic chuck apparatus of claim 1, wherein the pyrolytic boron nitride contains 0.01 to 10% by weight of carbon.

3. The electrostatic chuck apparatus of claim 1, wherein the pyrolytic boron nitride contains 0.01 to 20% by weight of at least one element selected from silicon, aluminum, yttrium, and titanium.

4. The electrostatic chuck apparatus of claim 1, wherein said insulating layer has a surface roughness Ra of less than 1 μm and Rmax of less than 3 μm.

5. The electrostatic chuck apparatus of claim 1, wherein said insulating layer is formed by chemical vapor deposition.
